(19) United States
(12) Patent Application Publication
(10) Pub. No.: US 2024/0024978 A1
(43) Pub. Date: Jan. 25, 2024

(54) PROCESSES FOR ADDITIVE MANUFACTURE AND SURFACE CLADDING

(71) Applicant: WAAM3D Limited, Buckinghamshire (GB)

(72) Inventors: Stewart WILLIAMS, Beford, Bedfordshire (GB); Jialuo DING, Beford, Bedfordshire (GB)

(21) Appl. No.: 18/256,575

(22) PCT Filed: Dec. 9, 2021
(86) PCT No.: PCT/EP2021/085002

§ 371 Date: Jun. 8, 2023

(30) Foreign Application Priority Data
Dec. 10, 2020 (GB) 2019452.8

(51) Int. Cl. B23K 9/04; B33Y 10/00; B33Y 30/00; B33Y 50/02; B23K 9/173

(52) U.S. Cl. CPC B23K 9/042; B33Y 10/00; B33Y 30/00; B33Y 50/02; B23K 9/173

(57) ABSTRACT

A process for producing a 3D article by additive manufacture is provided. The method includes the steps of: forming a meltpool on an already-existing part of the article using heat supplied to the article by a gas metal arc welding device having one or more consumable electrodes, and moving the meltpool relative thereto; simultaneously feeding into the moving meltpool: (i) the one or more consumable electrodes of the gas metal arc welding device to provide a first material feed rate into the meltpool, and (ii) a non-electrode, supplementary feedstock to provide a second material feed rate into the meltpool, whereby a layer of material is deposited and fused on the already-existing part; and repeating the forming and moving, and the feeding steps to build up successive layers of material, and thereby produce the 3D article. The ratio of the first material feed rate to the second material feed rate is varied in performance of the feeding step. A related process for surface cladding an article is also provided.

### FIELD OF THE DISCLOSURE

The present disclosure relates to a process for producing a 3D article by additive manufacture and a related process for surface cladding an article.

### BACKGROUND

Additive Manufacture (AM) is a technology that enables the creation of near net-shape 3D articles, typically based on a computer aided design (CAD) software model of the article. AM involves the deposition and fusing of multiple successive layers of one or more materials, such as metals, to build up the article. Significant advantages of AM, when compared to conventional methods of manufacturing 3D articles, such as casting or machining, include a reduction in production time and a reduction in the “buy-to-fly ratio”, i.e. the weight of material that needs to be purchased relative to the weight of that material in final manufactured part. The reduced material consumption, in particular, helps to reduce overall production costs.

In AM, the material from which the 3D article is to be made, i.e. the feedstock, is supplied to a specified location where it enters a meltpool formed on a substrate. The location of the meltpool is continuously moved around on the substrate. The melted feedstock layer fuses to the substrate, and further successive layers of material are then deposited in a similar manner on the previously deposited layers, to build up the 3D article. The substrate can be an already-existing component, onto which new features are added by AM.

Generally, an energy source such as a plasma arc, an electron beam or a laser is used to form the meltpool. This energy source can also be used to provide the energy to melt the feedstock as it enters the meltpool and to govern the overall temperature of the process (and therefore govern the cooling conditions and the microstructure and mechanical properties of the 3D article).

Wire+arc additive manufacture (WAAM) may be used for producing largescale articles. For example, titanium aerospace parts with masses of tens of kg have conventionally been formed by machining from forgings. However, by adopting a WAAM approach, material consumption, costs and lead times can all be reduced relative to this conventional approach.

Such WAAM typically utilises a Plasma Transferred Arc (PTA) process, having a non-consumable electrode with addition of material by a separate feed wire. In PTA the rate of energy input (power) and material feed rate are independently controllable, allowing high control of deposition conditions, which in turn leads to accurate deposition with a high level of thermal control.

This thermal control is important for building high quality parts, as keeping the temperature and size of the meltpool relatively constant, generally helps to reduce changes in the deposited geometry, layer height errors and defects. Specifically, such changes mainly occur for two reasons: 1) a general increase in temperature of the part; 2) changes in thermal mass. Thermal mass variations arise from changes in part geometry, e.g. building away from the substrate, varying wall widths, wall intersections and crossovers.

More particularly, even at a fixed material deposition rate per unit length the deposited geometry (layer height, layer width and contact angle) depends on the local thermal conditions. It is generally important to maintain a constant layer height in AM as the component is typically made of hundreds or thousands of layers. If there is an error in the actual layer height compared to the planned one then there will be geometric errors in the component, or worse the deposition process may fail so that the part cannot be built. In addition, layers are general deposited next to each other to enable wider component geometries than a single bead. The spacing between adjacent beads is set based on the expected deposited bead width. If this changes it can generate lack of fusion defects (if the width decreases) or geometry errors (if the width increases).

The deposited material microstructure, and therefore physical properties, also depends on the local thermal conditions during the freezing and cooling stages. It is generally desirable to have homogenous properties throughout a component to ensure uniform mechanical performance.

Thus, whether the local thermal conditions vary due to e.g. a change in local geometry of the underlying materials, or whether the overall temperature of the component increases due to the absorbed energy, it can be beneficial to be able to compensate for these changes by varying the energy input per unit length of the process. However, preferably this should be done without changing the material feed rate per unit length as this can otherwise change the deposited material geometry.

A limitation of PTA-based WAAM is its relatively low deposition rate, typically 1 kg/hr for titanium and 2-3 kg/hr for denser metals. This limit is due to the effects of arc pressure. If the electrode current is increased so does arc pressure, forming a depression in the meltpool which can lead to instabilities and defects.

This may not be such a problem for aerospace applications, but in non-aerospace industry sectors, such as energy, mining and construction, manufactured parts can be significantly more massive than in the aerospace sector, with articles being formed of low cost materials such as steel and having weights of 100s to 1000s of kg. Thus, while it would be desirable to be able to make such articles using WAAM in order to enjoy benefits such as: reductions in manual processes, improved performance, greater design freedom and increased customisability, a step change in WAAM build rate is desirable in order to provide realistic build times.

Higher build rates are possible by basing WAAM on a Gas Metal Arc (GMA) process, as this has significantly lower arc pressures due to its use of a consumable electrode and absence of a plasma gas constriction. GMA processes include MIG (metal inert gas), and MAG (metal active gas) processes. In the latter, active gases such as CO₂/O₂/H₂ are added for e.g. for control of oxidation or arc stability.

However there are problems associated with using GMA in high build rate applications. Firstly, in GMA power input and material feed rate are strongly linked, so that independent thermal control of the process is limited. For example, the heat or energy input per unit length (EI) is the power supplied by the GMA device divided by the travel speed (TS) of the meltpool, and thus to change the EI in WAAM based on conventional GMA (or indeed based on any similar AM process) requires changing either the power input or TS. The GMA power input can be adjusted in small amounts by adjusting the “trim”, which has the effect of lengthening the arc, and thereby increasing the arc voltage and the power input. Another possibility is to change to gas mixes containing He, but this expensive and not suitable for adjustments in real time. Thus the only practical option for changing the GMA power input significantly is changing the electrode current (power input and electrode current being linearly dependent on each other). However, varying the electrode current requires changing the wire feed speed (WFS) of the consumable electrode for stable metal transfer. This is discussed for example in Lee, H. K. et al., Int. J. Nav. Archit. Ocean Eng. (2015) 7:770-783 (incorporated herein by reference). Moreover, in WAAM the rate of material deposition per unit length, defined by the WFS/TS ratio, has to be kept constant in order to maintain a constant deposition geometry. Therefore, if the WFS or the TS is changed the other one needs to change in the same sense to provide a constant deposition geometry, leading to no change in EI and thus no thermal control.

### SUMMARY

It would be desirable to provide a WAAM process which addresses these issues.

Accordingly, in a first aspect there is provided a process for producing a 3D article by additive manufacture, wherein the method includes the steps of:
forming a meltpool on an already-existing part of the article using heat supplied to the article by a gas metal arc welding device having one or more consumable electrodes, and moving the meltpool relative thereto;
simultaneously feeding into the moving meltpool: (i) the one or more consumable electrodes of the gas metal arc welding device to provide a first material feed rate into the meltpool, and (ii) a non-electrode, supplementary feedstock to provide a second material feed rate into the meltpool, whereby a layer of material is deposited and fused on the already-existing part; and
repeating the forming and moving, and the feeding steps to build up successive layers of material, and thereby produce the 3D article;
wherein the ratio of the first material feed rate to the second material feed rate is varied in performance of the feeding step.

In this way, higher overall build rates can be achieved for a given power input compared to conventional GMA processes without the supplementary feedstock.

The total feed rate is the sum of the first material feed rate and the second material fed rate. Conveniently exterior parts of the article may be built up at relatively low total feed rates while interior parts of the article may be built up at relatively high total feed rates. Low total feed rates typically provide higher resolutions and therefore better surface finishes, and are thus more suitable for exterior parts of the article, while resolution can be sacrificed for high total feed rates in interior parts of the article.

A related process can be used for surface cladding an article. Accordingly, in a second aspect there is provided a process for surface cladding an article, wherein the method includes the steps of:
forming a meltpool on the surface of the article using heat supplied to the article by a gas metal arc welding device having one or more consumable electrodes, and moving the meltpool relative thereto; and
simultaneously feeding into the moving meltpool: (i) the one or more consumable electrodes of the gas metal arc welding device to provide a first material feed rate into the meltpool, and (ii) a non-electrode, supplementary feedstock to provide a second material feed rate into the meltpool, whereby a cladding layer of material is deposited and fused on the surface of the article;
wherein the ratio of the first material feed rate to the second material feed rate is varied in performance of the feeding step.

Like the process of the first aspect for producing a 3D article, the cladding process of the second aspect enables higher cladding rates to be achieved for a given power input compared to conventional GMA processes without the supplementary feedstock.

Some optional features of the present disclosure will now be set out. These are applicable singly or in any combination with any aspect of the present disclosure except where such a combination is clearly impermissible or expressly avoided.

Conveniently, the ratio of the first material feed rate to the second material feed rate can be varied to vary the power supplied by the gas metal arc welding device for a given combined sum of the first and second material feed rates. Advantageously, thermal control of the process can thereby be achieved by, for example, simultaneously varying the first material feed rate and the second material feed rate, such that the ratio of the total material feed rate (i.e. the first feed rate+the second feed rate) to the TS is kept constant for a given TS. Another option to varying the ratio of the first material feed rate to the second material feed rate is to vary the second material feed rate for a given first material feed rate (and therefore given supplied power), while simultaneously varying the TS so that the ratio of the total material feed rate to the TS is kept constant. However the variation in TS will lead to a variation in the EI. This option therefore can allow the feed rate to be maximised whilst changing the EI, which can advantageously enable maximisation of productivity. Preferably, the process may further include measuring a local temperature of the article, the measurement typically being made ahead of the meltpool. The ratio of the first material feed rate to the second material feed rate can then be varied based on the measured local temperature. In this way, closed loop control of the process can be achieved.

During the moving of the meltpool, cooling fluid may be applied to the article to improve thermal control of the process. The cooling fluid can conveniently be a cryogenic liquid or chilled gas, such as Ar, N₂ or CO₂. The amount and timing of application of the cooling fluid can be based on the local geometry of the article and/or a measured local temperature of the article ahead of the meltpool.

The supplementary feedstock may be one or more feed wires or tapes.

The process may further include preheating the supplementary feedstock to a predetermined temperature before feeding into the meltpool (for example by electrical resistance heating, induction heating, laser heating or non-transferred plasma arc heating). Such pre-heating can also be used to improve thermal control of the process. In particular, the predetermined temperature can be varied during the moving of the meltpool to improve thermal control of the process. The amount and timing of preheating can be based on the local geometry of the article and/or on a measured local temperature of the article, e.g. ahead of the meltpool.

In a third aspect, there is provided a system for producing a 3D article by additive manufacture in which a meltpool is formed on an already-existing part of the article using heat supplied to the article by a gas metal arc welding device having one or more consumable electrodes, the meltpool is moved relative to the already-existing part to deposit and fuse a layer of material on the already-existing part, and the forming and moving and feeding are repeated to build up successive layers of material, and thereby produce the 3D article, the system comprising:
the gas metal arc welding device having the one or more consumable electrodes which provide a first material feed rate into the meltpool;
a feedstock directing arrangement for feeding a non-electrode, supplementary feedstock into the meltpool simultaneously with the one or more consumable electrodes, the supplementary feedstock providing a second material feed rate into the meltpool; and
a computer controller configured to control movement of the gas metal arc welding device and the feedstock directing arrangement relative to the already-existing part, and to control the first and second feed rates;
wherein the computer controller is further configured such that the ratio of the first material feed rate to the second material feed rate is variable while controlling the first and second feed rates.

Thus the system of the third aspect is suitable for performing the process of the first aspect. However, it is also suitable for performing the process of the second aspect. Therefore, the system is also a system for surface cladding an article in which a meltpool is formed on the article using energy supplied to the article by a gas metal arc welding device having one or more consumable electrodes, the meltpool is moved relative to the article to deposit and fuse a cladding layer of material on the surface of the article.

The ratio of the first material feed rate to the second material feed rate may be variable by the computer controller to vary the power supplied by the gas metal arc welding device for a given combined sum of the first and second material feed rates.

Additionally or alternatively, the ratio of the first material feed rate to the second material feed rate may be varied by varying the second material feed rate for a given first material feed rate. The computer controller may then be further configured to simultaneously vary the travel speed of the meltpool so that the ratio of the sum of the first material feed rate and the second material fed rate to the travel speed is kept constant.

The system may further comprise a measuring device for measuring a local temperature of the article, e.g. ahead of the meltpool. The computer controller may then be further configured such that the ratio of the first material feed rate to the second material feed rate is variable based on the measured local temperature. Additionally or alternatively, the computer controller may be further configured such that the ratio of the first material feed rate to the second material feed rate is variable based on: a predetermined requirement for a change in overall energy input, e.g. due to local changes in geometry of the article which change the thermal mass; and/or to achieve a predetermined temperature rise or to limit an unwanted temperature rise due to energy accumulation.

The system may further comprise a cooling device for applying cooling fluid to the article, wherein the computer controller may be further configured to control the cooling device. For example, the control may be based on: the local geometry of the article; a need to achieve predetermined temperature rise or to limit an unwanted temperature rise due to energy accumulation; and/or on a measured local temperature of the article (e.g. ahead of the meltpool).

Conveniently, the supplementary feedstock may be one or more feed wires or tapes.

The system may further comprise a heating device for preheating the supplementary feedstock to a predetermined temperature before feeding into the meltpool, wherein the computer controller may be further configured to control the heating device. For example, the control may be based on: the local geometry of the article; a need to achieve predetermined temperature rise or to limit an unwanted temperature rise due to energy accumulation; and/or on a measured local temperature of the article (e.g. ahead of the meltpool).

### BRIEF DESCRIPTION OF THE DRAWINGS

Embodiments will now be described by way of example only, with reference to the Figures, in which:

FIG. 1 system for producing a 3D article by additive manufacture; and

FIG. 2 shows experimental plots of energy input per unit length (EI) against ratios of R=(cold wire WFS)/(hot wire WFS) for pulsed and DC MIG at different values of TS and for a fixed total WFS of either 6.38 or 9.57 kg/h;

FIG. 3 shows experimental plots of EI against varying ratios of R for DC MIG at different values of total WFS, and for a fixed TS of 0.6 m/min and a maximum hot wire WFS of 8 kg/h;

FIG. 4 shows, for five pulsed MIG experiments, a plot of EI against R and TS and the corresponding plot of total WFS against R and TS, in all five experiments, the hot wire WFS being kept constant and the ratio of the total material feed rate to TS also being kept constant;

FIGS. 5A to 5H show respective cross-sections through single beads deposited at a total WFS of 6.38 kg/h and a TS of 0.8 m/min, but at different values of R;

FIGS. 6A to 6E show plots derived from the cross-sections of FIGS. 5A to 5H, FIG. 6A showing plots of bead height and bead width, FIG. 6B showing plots of bead aspect ratio and contact angle, 6C showing plots of bead penetration depth and depth of heat affected zone, FIG. 6D showing plots of penetration area into the substrate and deposited metal area for the cross-sections, and FIG. 6E showing plots of remelting ratio and dilution; and

FIG. 7 shows a schematic transverse cross-section through an article built up by AM using a skin and core approach.

### DETAILED DESCRIPTION

Aspects and embodiments of the present invention will now be discussed with reference to the accompanying figures. Further aspects and embodiments will be apparent to those skilled in the art.

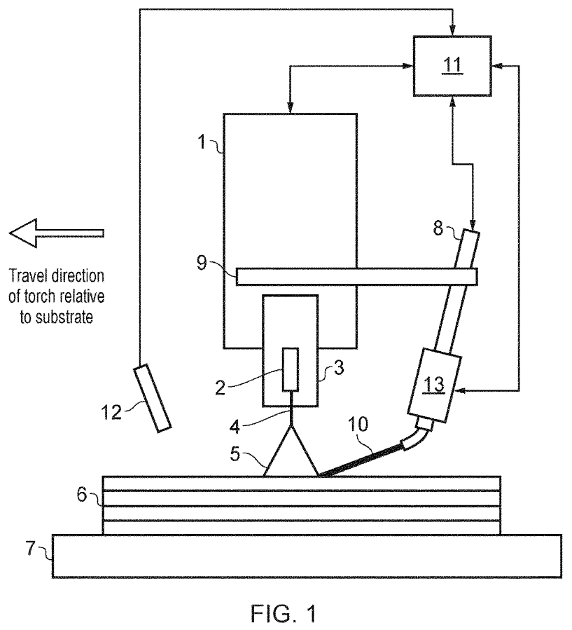

FIG. 1 shows schematically a system for producing a 3D article by additive manufacture. The system includes a GMA torch 1 having a contact tip 2 and a gas shroud 3. A hot wire 4 emerges from the contact tip to form a consumable electrode, an arc 5 being formed between the hot wire and the growing article 6 formed on a substrate 7. Alternatively the system can be used for surface cladding an existing article.

The arc 5 forms a meltpool on the article 6 into which the hot wire 4 is fed. In addition however, a feeder tube 8 is attached by a clamp assembly 9 to the GMA torch 1, and a supplementary feedstock, non-electrode cold wire 10 is fed from the feeder tube, simultaneously with the hot wire into the advancing meltpool. The terms “hot” and “cold” are used to distinguish respectively the consumable electrode and the non-electrode feedstock, although of course the materials of both wires 4, 10 ultimately mix in and attain the temperature of the meltpool. The cold wire is shown entering the meltpool from the rear, but it can also enter from the front or the side.

The cross-sectional areas of the hot and cold wires can be the same or one can be larger than the other. The wires can also have the same or different cross-sectional shapes, e.g. round, profiled, strip etc.

The feed rate of the hot wire 4 into the meltpool provides a first material feed rate, and the feed rate of the cold wire 10 into the meltpool provides a second material feed rate. These feed rates are controlled by a computer controller 11, which also controls movement of the GMA torch 1 relative to the substrate 7 and GMA power input.

With this system, thermal control can be achieved by varying the WFS of the consumable electrode (hot wire 4) and the WFS of the cold wire 10 simultaneously, such that the total WFS and therefore WFS/TS ratio is kept constant. Alternatively, the WFS of the cold wire 10 can be varied whilst maintaining a constant WFS for the hot wire 4 (and therefore maintaining a constant power input) but simultaneously varying the TS so that the total WFS/TS ratio is kept constant but the EI is varied.

In general, the compositions of the hot wire and the cold wire are the same so that the composition of the built up material does not vary with changes to the ratio of the cold wire WFS to the hot wire WFS. However, this does not exclude that in some special applications wires of different composition could be used, e.g. two different low carbon steels or two different aluminium alloys.

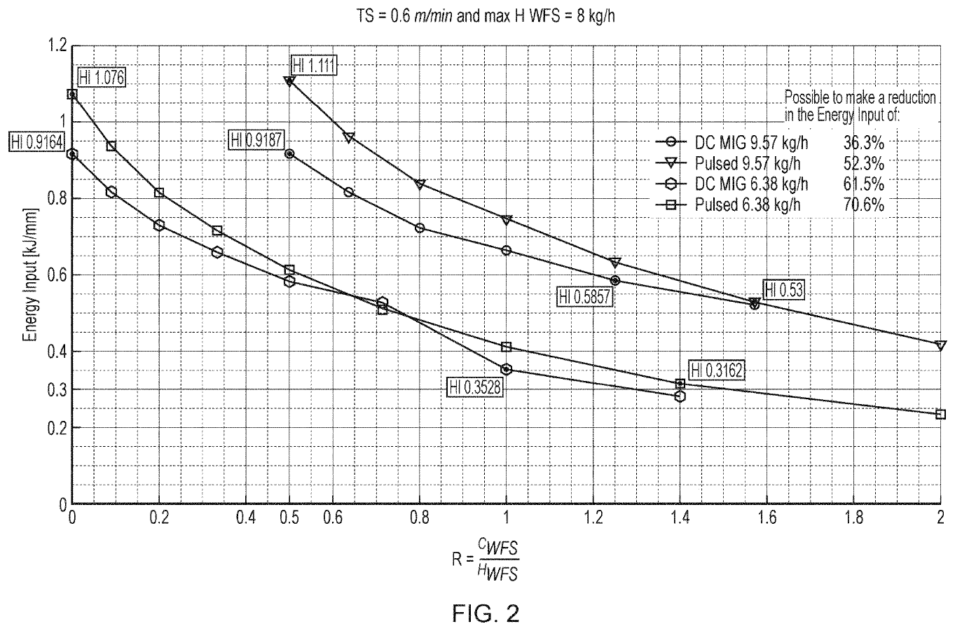

FIG. 2 shows experimental plots of energy input per unit length (EI) against ratios of R=(cold wire WFS)/(hot wire WFS) for pulsed and DC MIG at different values of TS and for a fixed total WFS of either 6.38 kg/h or 9.57 kg/h, and demonstrates that continuous variation of the EI is achievable by changing the ratio of the cold wire to hot wire feed rates. In all plots the hot wire and the cold wire are ER90 low carbon steel.

Advantageously, the cold wire addition can also be used to increase the overall deposition rate. Indeed, plural cold wires and/or plural hot wires can be used to increase the overall deposition rate still further and/or to improve melting characteristics of the supplementary feedstock. Additionally or alternatively, the cold wire may be pre-heated to a predetermined temperature under the control of the computer controller 11 to increase the power input. Thus such pre-heating can be used as a further means of thermal control. For example, the predetermined temperature can be increased for parts of the article where thermal losses are higher and reduced where they are lower. Additionally or alternatively, the predetermined temperature can be varied based on a local temperature of the part, typically measured ahead of the meltpool (discussed in more detail below). The pre-heating can be achieved in various ways, such as electrical resistance heating, induction heating, laser heating, and non-transferred plasma arc heating.

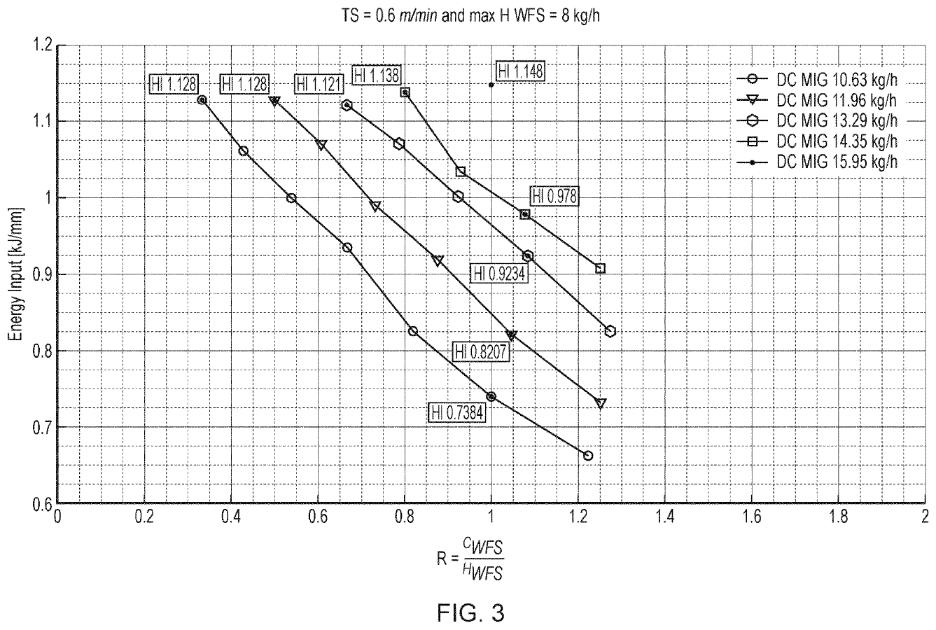

FIG. 3 shows experimental plots of EI against varying ratios of R for DC MIG at different values of total WFS, and for a fixed TS of 0.6 m/min and a maximum hot wire WFS of 8 kg/h. Again in all plots the hot wire and the cold wire are ER90 low carbon steel. These plots demonstrate that the range of thermal control is determined by the total WFS; the higher this is the lower is the range of thermal control.

In particular, the plot for a total WFS of 10.63 kg/h has an R value of 0.33 at its highest EI, and an R value of just over 1.2 at its lowest EI. Lower values of EI (with higher values of R) at this total WFS are not achievable as there is insufficient energy to melt the cold wire. The plots at higher values of total WFS then start at R values that provide approximately the same highest EI and are pursued to the lowest achievable values of EI (highest achievable R values). The plots show that increasing the total WFS leads to a lower thermal control range.

However, if necessary, increasing the total WFS for a given TS while maintaining the thermal control can be achieved by using plural hot wires, i.e. consumable electrodes.

The results of FIG. 3 were obtained for a TS of 0.6 m/min, but the range of thermal control can also be increased by reducing the TS, while conversely increasing the TS reduces the range of thermal control.

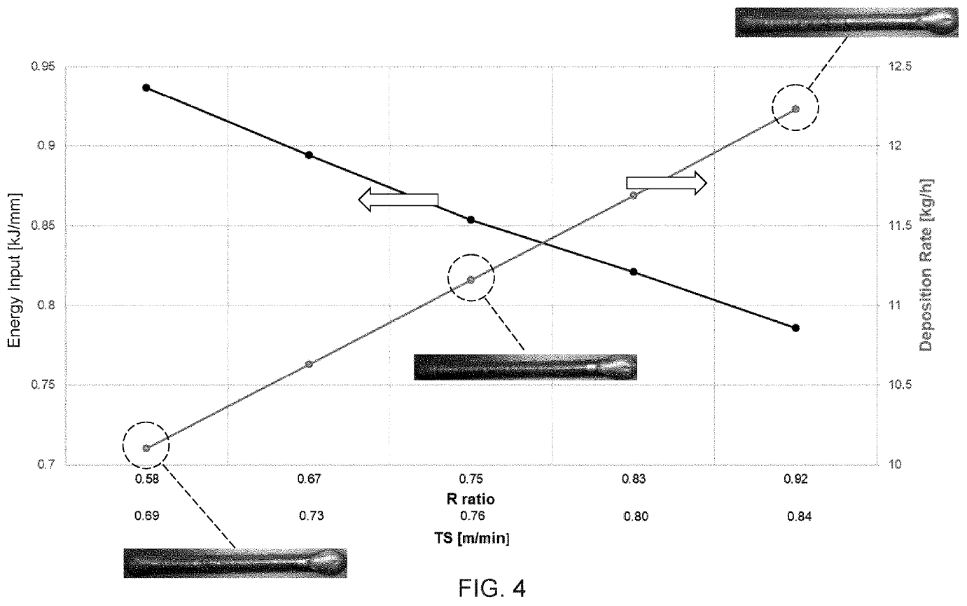

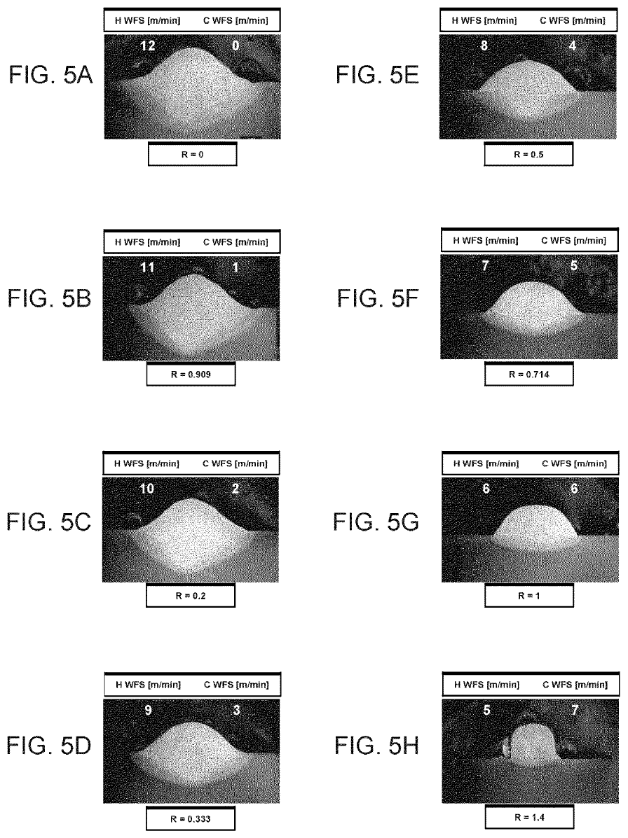

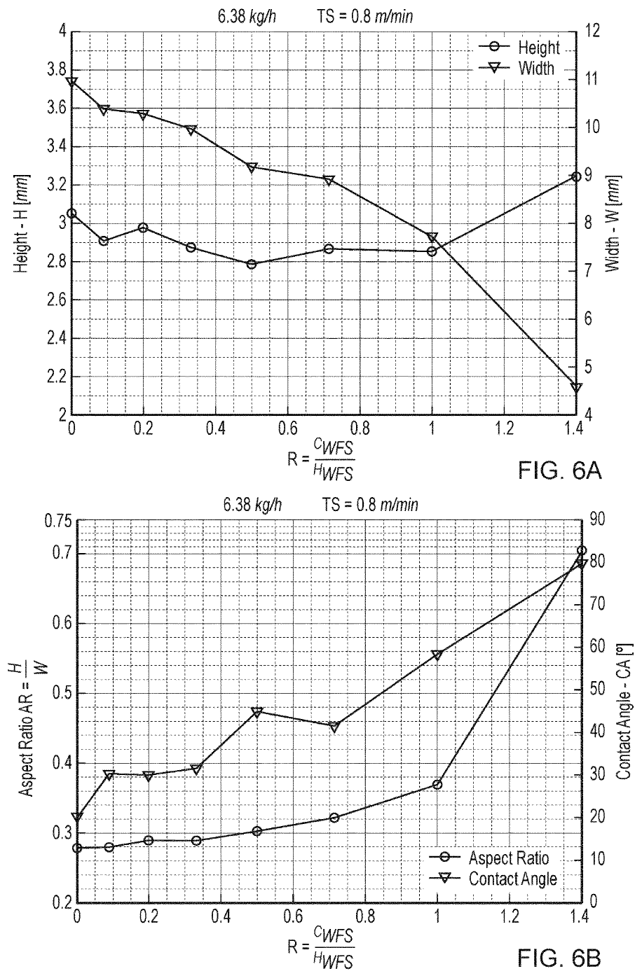

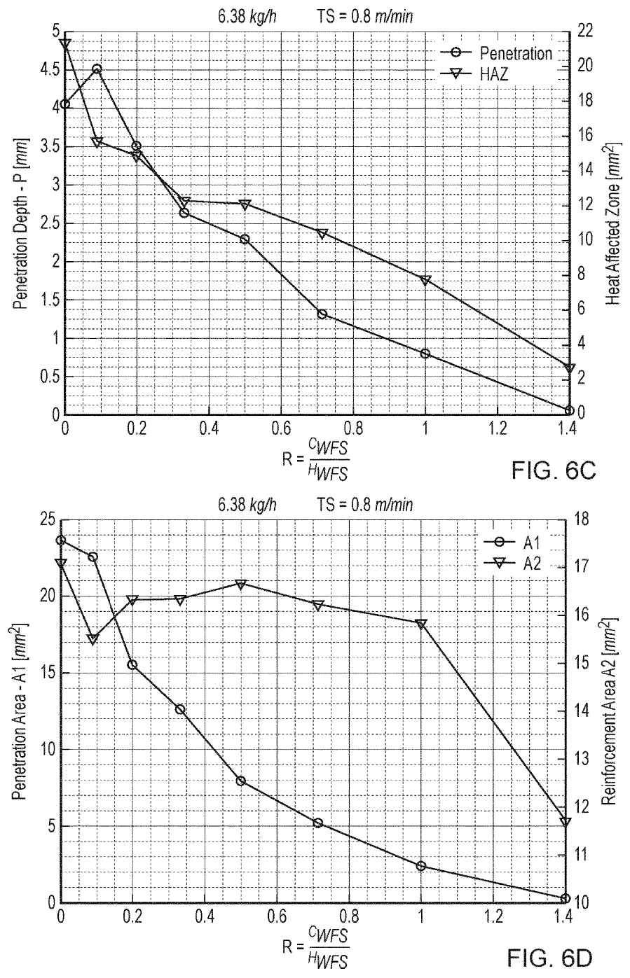

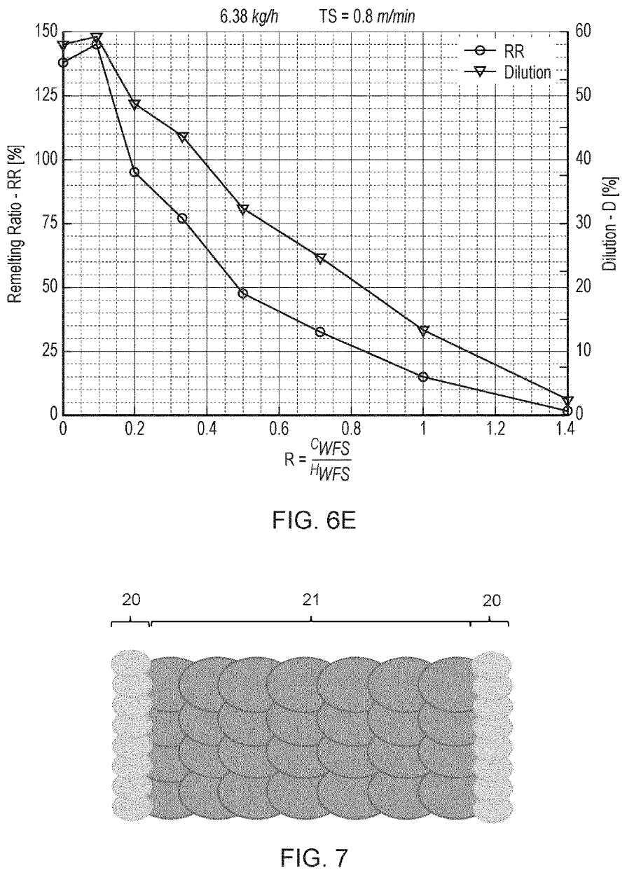

FIG. 4 shows, for five pulsed MIG experiments, a plot of EI against R and TS and the corresponding plot of total WFS against R and TS. In all five experiments, the hot wire and the cold wire are ER90 low carbon steel. In addition, in all five experiments the hot wire WFS was kept constant and the ratio of the total material feed rate to TS was also kept constant. Photographs of single tracks of added material for three of the experiments are also provided in FIG. 4, and show that the tracks were all deposited with approximately the same width. These results demonstrate that it is possible to maximise the build rate for a given supplied power. Geometry control is also possible by varying R. FIGS. 5A to 5H show respective cross-sections through single beads deposited at a total WFS of 6.38 kg/h and a TS of 0.8 m/min, but at different values of R. In all of FIGS. 5A to 5H the hot wire and the cold wire are ER90 low carbon steel. FIG. 6A shows plots of bead height and bead width for these cross-sections, and demonstrates that increasing R reduces the bead width while the height remain relatively unchanged. FIG. 6B shows plots of bead aspect ratio (height/width) and contact angle (i.e. the internal angle that the deposited metal makes with the substrate) for the cross-sections, and demonstrates that contact angle increases with R. Lower contact angles are generally preferred for AM, with the practical upper limit being about 60°. FIG. 6C shows plots of bead penetration depth into the substrate and depth of heat affected zone (HAZ) for the cross-sections, FIG. 6D shows plots of penetration area (A1) into the underlying material and deposited metal area (A2) for the cross-sections, and FIG. 6E shows plots of remelting ratio (RR=A1/A2) and dilution (D=(A1-A2)/A2)) for the cross-sections. Penetration depth is a metric often used in welding, but for AM the remelting ratio RR is more useful. The RR plot of FIG. 6E shows that increasing the WFS of the cold wire greatly reduces RR, which is beneficial as RR should generally be as low as possible for AM. For simple cladding, the dilution D is often used as a metric, and this also should generally be as low as possible (usually less than 5%). The D plot of FIG. 6E shows that increasing the WFS of the cold wire also greatly reduces D.

Thus changing the EI by independently varying the WFS of the hot wire 4 and the WFS of the cold wire 10 allows:
1. The deposited bead shape and the material microstructure (and consequent mechanical properties) to be kept constant even as thermal losses change due to the thermal mass changing with changes to the local geometry of the part.
2. The deposited bead shape and the material microstructure (and consequent mechanical properties) to be kept constant even as the overall part temperature changes (typically increases) due to the deposition process. Control of the EI can thus be linked to a process in which the temperature of the part is measured just before deposition, e.g. using a pyrometer or other temperature sensing device 12 which moves with the GMA torch 1 to measure a local temperature of the part ahead of the meltpool and provides the temperature measurement to the computer controller 11.
3. The deposited bead shape to be changed, e.g. to accommodate different geometries and desired finishes of the growing part.
4. Further control over the deposition process can be exercised by providing a heating device 13 which, under the control of the computer controller 11, preheats the cold wire 10 to a predetermined temperature before feeding into the meltpool. For example, the heating device can conveniently comprise an RF induction coil through which the cold wire is fed before conveyance to the meltpool.

Although the system can provide high deposition rates, this generally causes an associated problem in that the resolution and deposition quality provided by wide and/or high deposition tracks is typically low. In particular, high deposition rates can produce poor quality, rough surface finishes. However, this problem can be addressed by adopting a skin and core approach, as shown in the schematic transverse cross-section of FIG. 7, in which exterior parts 20 of the article are formed using low build rates and layer heights to provide high resolutions and low surface roughnesses, while core parts 21 are filled using much higher build rates and layer heights.

More generally, variable resolution can be used as needed in order to appropriately balance build rate and surface finish.

A further problem that can be encountered when using WAAM to manufacture parts at high build rates is overall temperature control. For example, build rates of >10 kg/hr require many kW of input power, which can lead to overheating of the part. One option is to introduce cooling times between added layers, but this significantly reduces productivity. Thus to ensure high productivity, in-process active cooling systems can be applied. For example, cryogenic liquid or chilled gas (e.g. Ar, N₂ or CO₂) cooling can used in the system of FIG. 1 by directing the cryogenic liquid or chilled gas onto the growing part with suitable a nozzle(s). Control of such cooling can be performed by the computer controller 11, so that it is a fully integrated part of the process. The computer controller 11 can determine the amount of cooling on the basis of temperature measurements on the article.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

1. A process for producing a 3D article by additive manufacture, wherein the method includes the steps of:
forming a meltpool on an already-existing part of the article using heat supplied to the article by a gas metal arc welding device having one or more consumable electrodes, and moving the meltpool relative thereto;
simultaneously feeding into the moving meltpool: (i) the one or more consumable electrodes of the gas metal arc welding device to provide a first material feed rate into the meltpool, and (ii) a non-electrode, supplementary feedstock to provide a second material feed rate into the meltpool, whereby a layer of material is deposited and fused on the already-existing part; and
repeating the forming and moving, and the feeding steps to build up successive layers of material, and thereby produce the 3D article;
wherein the ratio of the first material feed rate to the second material feed rate is varied in performance of the feeding step.

2. The process of claim 1, wherein the total feed rate is the sum of the first material feed rate and the second material fed rate, exterior parts of the article being built up at relatively low total feed rates and interior parts of the article being built up at relatively high total feed rates.

3. A process for surface cladding an article, wherein the method includes the steps of:
forming a meltpool on the surface of the article using heat supplied to the article by a gas metal arc welding device having one or more consumable electrodes, and moving the meltpool relative thereto; and
simultaneously feeding into the moving meltpool: (i) the one or more consumable electrodes of the gas metal arc welding device to provide a first material feed rate into the meltpool, and (ii) a non-electrode, supplementary feedstock to provide a second material feed rate into the meltpool, whereby a cladding layer of material is deposited and fused on the surface of the article;
wherein the ratio of the first material feed rate to the second material feed rate is varied in performance of the feeding step.

4. The process of claim 3, wherein the ratio of the first material feed rate to the second material feed rate is varied to vary the power supplied by the gas metal arc welding device for a given combined sum of the first and second material feed rates.

5. The process of claim 3, wherein the second material feed rate is varied for a given first material feed rate to vary the ratio of the first material feed rate to the second material feed rate, while simultaneously the travel speed of the meltpool is varied so that the ratio of the sum of the first material feed rate and the second material fed rate to the travel speed is kept constant.

6. The process of claim 4, further including measuring a local temperature of the article, wherein the ratio of the first material feed rate to the second material feed rate is varied based on the measured local temperature.

7. The process of claim 3, wherein, during the moving of the meltpool, cooling fluid is applied to the article.

8. The process of claim 3, further including preheating the supplementary feedstock to a predetermined temperature before feeding into the meltpool.

9. The process of claim 8, wherein, during the moving of the meltpool, the predetermined temperature is varied.

10. A system for producing a 3D article by additive manufacture in which a meltpool is formed on an already-existing part of the article using heat supplied to the article by a gas metal arc welding device having one or more consumable electrodes, the meltpool is moved relative to the already-existing part to deposit and fuse a layer of material on the already-existing part, and the forming and moving and feeding are repeated to build up successive layers of material, and thereby produce the 3D article, the system comprising:
the gas metal arc welding device having the one or more consumable electrodes which provide a first material feed rate into the meltpool;
a feedstock directing arrangement for feeding a non-electrode, supplementary feedstock into the meltpool simultaneously with the one or more consumable electrodes, the supplementary feedstock providing a second material feed rate into the meltpool; and
a computer controller configured to control movement of the gas metal arc welding device and the feedstock directing arrangement relative to the already-existing part, and to control the first and second feed rates;
wherein the computer controller is further configured such that the ratio of the first material feed rate to the second material feed rate is variable while controlling the first and second feed rates.

11. The system of claim 10, wherein the ratio of the first material feed rate to the second material feed rate is variable by the computer controller to vary the power supplied by the gas metal arc welding device for a given combined sum of the first and second material feed rates.

12. The system of claim 10, wherein the ratio of the first material feed rate to the second material feed rate is varied by varying the second material feed rate for a given first material feed rate, and wherein the computer controller is further configured to simultaneously vary the travel speed of the meltpool so that the ratio of the sum of the first material feed rate and the second material fed rate to the travel speed is kept constant.

13. The system of claim 10, further comprising:
a measuring device for measuring a local temperature of the article, wherein the computer controller is further configured such that the ratio of the first material feed rate to the second material feed rate is variable based on the measured local temperature.

14. The system of claim 10, further comprising:
a cooling device for applying cooling fluid to the article, wherein the computer controller is further configured to control the cooling device.

15. The system of claim 10, further comprising:
a heating device for preheating the supplementary feedstock to a predetermined temperature before feeding into the meltpool, wherein the computer controller is further configured to control the heating device.
